(19) United States
(12) Patent Application Publication
(10) Pub. No.: US 2015/0286739 A1
(43) Pub. Date: Oct. 8, 2015

(54) HTML5-PROTOCOL-BASED WEBPAGE PRESENTATION METHOD AND DEVICE

(71) Applicant: BEIJING JOYCHINA NETWORK TECHNOLOGIES CO., LTD., Beijing (CN)

(72) Inventor: Chenghong Xie, Beijing (CN)

(73) Assignee: LAYABOX INC., Beijing (CN)

(21) Appl. No.: 14/438,307

(22) PCT Filed: Jul. 23, 2013
(86) PCT No.: PCT/CN2013/079845

§ 371 Date: Apr. 24, 2015

(30) Foreign Application Priority Data
Nov. 6, 2012 (CN) 201210438976.8

(51) Int. Cl. G06F 17/30

(52) U.S. Cl. CPC G06F 17/30896; G06F 17/30905

(57) ABSTRACT

Disclosed in an embodiment of the present application is an HTML5-protocol-based webpage presentation method, the method includes: acquiring an HTML5-protocol-based webpage resource; using Javascript Language to parse the webpage resource to generate a DOM object node; rendering the DOM object and presenting the webpage. Also disclosed in the embodiment of the present invention is an HTML5-protocol-based webpage presentation device. The embodiment of the present invention realizes support for the HTML5 protocol without using an external plug-in, thus avoiding the operations of plug-in installation, function upgrading and the like, and improving the presentation efficiency of an HTML5-protocol-based webpage.

This application is a national phase of International Application No. PCT/CN2013/079845, entitled “HTML5-PROTOCOL-BASED WEBPAGE PRESENTATION METHOD AND DEVICE”, filed on Jul. 23, 2013, which claims the priority to Chinese Patent Application No. 201210438976.8, entitled “HTML5-PROTOCOL-BASED WEBPAGE PRESENTATION METHOD AND DEVICE”, filed with the Chinese State Intellectual Property Office on Nov. 6, 2012, which is incorporated by reference in its entirety herein.

### BACKGROUND

1. Field of the Invention

The present application relates to the technical field of information presentation, and in particular to an HTML5-protocol-based webpage presentation method and a corresponding device.

2. Background of the Technology

The HTML5 (Hypertext Markup Language 5th, hypertext markup language standard, the fifth edition, which is also referred to as HTML standard version) is a new HTML protocol standard which is provided for replacing the HTML 4.01 developed in 1999 and the XHTML 1.0. The HTML5 protocol has two outstanding features as compared with the previous versions. Firstly, presentation performance of a Web webpage is enhanced. Secondly, Web application functions, such as a local database, are added, for providing more standard sets effectively enhancing internet applications by reducing requirements of a browser on a plug-in-based rich internet application (RIA, such as Adobe Flash, Microsoft Silverlight and Oracle JavaFX).

However, in the HTML5 protocol, due to the reduction in the requirement on the plug-ins, an existing browser (such as IE6.0 to IE8.0, Sogou, Firefox and Chrome) will not be able to achieve HTML5-protocol-based webpage presentation without an external plug-in program or necessary function updating.

### SUMMARY

To address the above technical problems, it is provided an HTML5-protocol-based webpage presentation method and a corresponding device in embodiments of the application, for achieving HTML5-protocol-based webpage presentation without an external plug-in program or function updating.

An HTML5-protocol-based webpage presentation method is provided in an embodiment of the application, which includes:

acquiring an HTML5-protocol-based webpage resource;

parsing the webpage resource by using Javascript language to generate DOM object nodes; and

rendering the DOM objects and performing webpage presentation.

Preferably, the process of parsing the webpage resource by using Javascript language to generate DOM object nodes may include:

performing lexical analysis on the webpage resource by using Javascript language to obtain an HTML tag; and

calling a DOM object creation function to create the DOM object nodes based on the HTML tag.

Further, preferably, after the process of performing lexical analysis on the webpage resource by using Javascript language to obtain an HTML tag, Javascript code corresponding to the HTML tag and for calling the DOM object creation function to create the DOM object nodes are generated, and the process of calling a DOM object creation function to create the DOM object nodes according to the HTML tag may include:

according to the HTML tag, calling the Javascript codes corresponding the HTML tag to create the DOM object nodes.

Preferably, the method may further include achieving control of the DOM object by using Javascript language, wherein the process of achieving control of the DOM object by using Javascript language may include:

obtaining the DOM object, a base class of the DOM object and a visual element interface by using Javascript language;

adding a DOM object node to and/or deleting a DOM object node from the DOM object according to the HTML tag; and or

setting an attribute of the DOM object node according to an attribute of the HTML tag.

Preferably, the method may further include controlling style of at least one DOM object node, wherein the process of controlling style of at least one DOM object node may include:

compiling a style resource of the DOM object node into Javascript code and packaging the Javascript code obtained by the compiling into a function; and

calling the function to perform style control on the corresponding DOM object node.

Further, preferably, the method may further include typesetting a changed DOM object if any, wherein the change may include addition, deletion and/or style variation of the DOM object node, and the process of typesetting a changed DOM object may include: by using Javascript language,

collecting the changed DOM object node and a sub-node of the changed DOM object node to form a typesetting collection;

calculating attribute information of the DOM object node in the typesetting collection; and

modifying the attribute information of the DOM object node before the change by using the attribute information of the DOM object node after the change.

Preferably, the process of rendering the DOM objects may include drawing a character, and the process of drawing a character may include:

retrieving in a preset image set to determine whether there is a picture with the size matching the size of the character in the preset image set; and

in a case that there is a picture with the size matching the size of the character in the preset image set, judging whether a character to be drawn is contained in the picture, drawing the character according to position information of the character in the picture in a case that a character to be drawn is contained in the picture, or drawing the character to be drawn in the picture and drawing the character according to position information of the character in the picture in a case that no character to be drawn is contained in the picture; or

in a case that there is no picture with the size matching the size of the character in the preset image set, creating a picture with the size matching the size of the character, drawing the character to be drawn in the picture, and drawing the character according to position information of the character in the picture.

Preferably, the process of rendering the DOM objects may include combining materials, and the process of combining materials may include:

creating a blank texture;

putting the object to be drawn into the texture, and recording position information of the object to be drawn in the texture; and

drawing the objects to be drawn onto a screen all at once according to the position information of the objects to be drawn in the texture when receiving a draw trigger.

It is further provided an HTML5-protocol-based webpage presentation device in the application, and the device includes an acquiring unit, a parsing unit and a rendering unit, wherein

the acquiring unit is configured to acquire an HTML5-protocol-based webpage resource;

the parsing unit is configured to parse the webpage resource by using Javascript language to generate DOM object nodes; and

the rendering unit is configured to render the DOM objects and perform webpage presentation.

Preferably, the parsing unit may include a lexical analyzing subunit and a DOM object node generating subunit, wherein

the lexical analyzing subunit may be configured to perform lexical analysis on the webpage resource by using Javascript language to obtain an HTML tag; and

the DOM object node generating subunit may be configured to call a DOM object creation function to create the DOM object nodes according to the HTML tag.

Further, preferably, the parsing unit may further include a code generating subunit configured to generate Javascript code corresponding to the HTML tag and for calling the DOM object creation function to create the DOM object nodes, after the lexical analysis is performed on the webpage resource by using Javascript language to obtain the HTML tag. And the DOM object node generating subunit may be configured to call the Javascript code corresponding the HTML tag to create the DOM object nodes.

Preferably, the device may further include a DOM object control unit configured to achieve control of the DOM object by using Javascript language, and the DOM object control unit may be configured to:

obtain the DOM object, a base class of the DOM object and a visual element interface by using Javascript language;

add a DOM object node to and/or delete a DOM object node from the DOM object according to the HTML tag; and/or

set an attribute of the DOM object node based on an attribute of the HTML tag.

Preferably, the device may further include a style control unit configured to control a style of at least one DOM object node, wherein the style control unit may be configured to:

compile a style resource of the DOM object node into Javascript code and package the Javascript code obtained by the compiling into a function; and

call the function to perform style control on the corresponding DOM object node.

Preferably, the device may further include a typesetting unit configured to typeset a changed DOM object if any, wherein the change may include addition, deletion and/or style variation of the DOM object node, and the process of typesetting a changed DOM object may include: by using Javascript language,

collecting the changed DOM object node and a sub-node of the changed DOM object node to form a typesetting collection;

calculating attribute information of the DOM object node in the typesetting collection; and

modifying the attribute information of the DOM object node before the change by using the attribute information of the DOM object node after the change.

Preferably, the process of rendering the DOM objects may include drawing a character, the rendering unit may include a character drawing unit, and the character drawing unit may include a retrieving subunit, a judging subunit, a creating subunit, a first drawing subunit and a second drawing subunit, wherein

the retrieving subunit may be configured to retrieve in a preset image set to determine whether there is a picture with the size matching the size of the character in the preset image set, trigger the judging subunit if there is a picture with the size matching the size of the character in the preset image set, or trigger the creating subunit if there is no picture with the size matching the size of the character in the preset image set;

the judging subunit may be configured to judge whether a character to be drawn is contained in the picture, trigger the first drawing subunit to draw the character according to position information of the character in the picture in a case that the character to be drawn is contained in the picture, or trigger the second drawing subunit to draw the character to be drawn in the picture and trigger the first drawing subunit to draw the character according to position information of the character in the picture in a case that no character to be drawn is contained in the picture; and

the creating subunit may be configured to create a picture with the size matching the size of the character, trigger the second drawing subunit to draw the character to be drawn in the picture, and trigger the first drawing subunit to draw the character based on position information of the character in the picture.

Preferably, the process of rendering the DOM objects may include combining materials, the rendering unit may include a material combining unit, and the material combining unit may include a texture creating subunit, a position information recording subunit and a third drawing subunit, wherein

the texture creating subunit may be configured to create a blank texture;

the position information recording subunit may be configured to put the object to be drawn into the texture and record position information of the object to be drawn in the texture; and

the third drawing subunit may be configured to draw the objects to be drawn onto a screen all at once according to the position information of the objects to be drawn in the texture when receiving a draw trigger.

In the embodiment of the application, the HTML5-protocol-based webpage resource is acquired, then the webpage resource is parsed by using Javascript language to generate the DOM object nodes, and then the DOM objects are rendered for webpage presentation. As compared with the conventional art, Javascript language is adopted as the language for parsing the HTML5-protocol-based webpage resource in the embodiment of the application. Since Javascript language is widely used in various webpage browsers, the support for the HTML5 protocol is achieved without an external plug-in program in the embodiment of the application, thus avoiding operations such as installing a plug-in or updating a function, and improving presentation efficiency of an HTML5-protocol-based webpage. Further, since the support for the HTML5 protocol is achieved only depending on Javascript language in the embodiment of the application, the technical solutions in the application can be widely applied to various platforms supporting Javascript language, for increasing or improving webpage presentation performances of these platforms, and providing an all-platform development mode.

### BRIEF DESCRIPTION OF THE DRAWINGS

In order to illustrate the technical solutions in the embodiments of the application or in the conventional art more clearly, drawings to be used in describing the conventional art or the embodiments of the application will be described briefly hereinafter. Apparently, the drawings described hereinafter are merely some embodiments of the application, and other drawings may be obtained by those ordinary skilled in the art based on those drawings without creative labor.

FIG. 1 is a flowchart of an HTML5-protocol-based webpage presentation method according to a first embodiment of the application;

FIG. 2 is a flowchart of an HTML5-protocol-based webpage presentation method according to a second embodiment of the application;

FIG. 3 is a flowchart of a method for drawing a character according to a third embodiment of the application;

FIG. 4 is a flowchart of a method for combining materials according to the third embodiment of the application;

FIG. 5(a) to FIG. 5(e) are schematic diagrams of the process of combining materials according to the third embodiment of the application; and

FIG. 6 is a block diagram of a structure of an HTML5-protocol-based webpage presentation device according to a fourth embodiment of the application.

### DETAILED DESCRIPTION

Hereinafter, the technical solution in the embodiment of the present application will be described clearly and completely in conjunction with the drawings in the embodiment of the present application, in order that those skilled in the art will understand the technical solutions in the application better. Obviously, the described embodiments are merely a few embodiments of the present application, but not all embodiments. All the other embodiments based on the embodiment in the present application obtained by those skilled in the art without creative labor will fall within the scope of protection of the present application.

### First Embodiment

A webpage presentation process includes a series of consecutive operations, such as downloading of a webpage resource, parsing of the webpage resource and rendering. Parsing processes of the webpage resource based on different protocol standards are different. Due to this difference, many browsers can not support, for example, an HTML5-protocol-based web resource. In the conventional art, to solve this problem, an external plug-in program or updating with a special updating software package is adopted for updating. However, these solutions are inconsistent with the purpose of reducing the usage of the plug-in in the HTML5. In this application, the paring process is performed by using Javascript language built in the browser, thereby solving the above problem better.

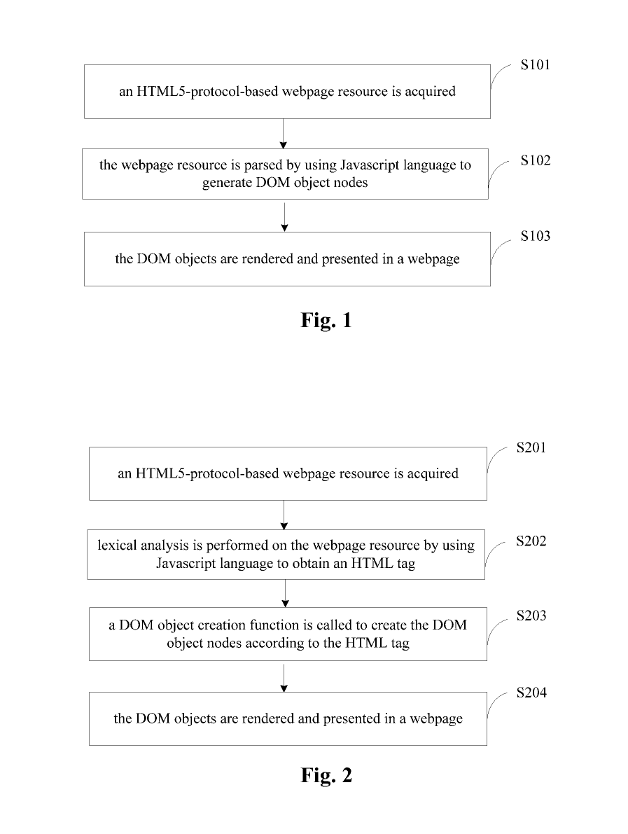

Referring to FIG. 1, which shows a flowchart of an HTML5-protocol-based webpage presentation method according to an embodiment of the application. The HTML5-protocol-based webpage presentation method includes steps S101 to S103 as follows.

In step S101, an HTML5-protocol-based webpage resource is acquired.

Acquiring a webpage resource is a basis for webpage presentation. Webpage resources include generally a webpage resource downloaded from a server (which is referred to as a primary webpage resource) and a webpage resource generated dynamically based on a resource downloaded from a server (which is referred to as a secondary webpage resource). The webpage resource from the server is the webpage resource provided to a browser by the server in response to an access request including a page address sent by a user to the server via the browser. The webpage resource downloaded from the server may be provided to the browser immediately. Alternatively, as desired in practice, the downloaded webpage resource may be cached firstly, and provided to the browser when the process of acquiring the webpage resource is triggered. Accordingly, in this embodiment, the HTML5-protocol-based webpage resource may be acquired in many ways, such as a way of an instant request immediate acquiring, or a way in which the webpage resource is extracted from the cache when the process of acquiring the webpage resource is triggered. The generated webpage resource is generated by running some program segments in the loaded webpage resource by means of the processing and calculating function of a local system, such as the webpage codes generated by running the script program, and the webpage resource generated by some controls triggered. It is to be noted, the webpage resource needed in the application includes both the webpage resource from the server and the webpage resource generated locally as described above, which are not differentiated particularly. Further, the specific type of the acquired HTML5-protocol-based webpage resource is not limited in this embodiment, and may be for example text, picture, sound, video or any combination thereof.

In step S102, the webpage resource is parsed by using Javascript language to generate DOM object nodes.

Javascript language is the webpage script language supported by the browser, is used in webpage information interaction and webpage logical control conventionally, and is dependent on the webpage and the browser. In this embodiment, Javascript language is taken as the operation language, and is adopted to parse the webpage resource to generate the DOM object nodes. The DOM (Document Object Model, document object model) object is a set of nodes or information segments organizing the page elements in a hierarchy, and is a standard assembly independent from a browser, a platform or a language.

In step S103, the DOM objects are rendered and presented in a webpage.

The DOM object reflects information such as the relations and positions of various page elements in the webpage. The page elements are expressed as the nodes of the DOM object. The information of the DOM object node, such as the position, is an attribute of the DOM object node. By rendering the integral DOM object including multiple DOM object nodes, the presentation of the page is achieved. During the rendering, any render supported by the browser may be selected to render the DOM objects, and the selection operation may be determined in initialization of the system. In case of multiple renders, for example, in a case that renders such as WebGL, Flash11 and HTML5 canvas are supported by the system, besides random selection of any render, a priority may be provided for each of the multiple renders, and the selection may be performed based on the priority of the render.

In this embodiment, the HTML5-protocol-based webpage resource is acquired, then the webpage resource is parsed by using Javascript language to generate a DOM tree presentation structure, and then the DOM tree presentation structure is rendered and presented. As compared with the conventional art, Javascript language is adopted as the language for parsing the HTML5-protocol-based webpage resource in this embodiment. Since Javascript language is widely used in various webpage browsers, the support for the HTML5 protocol is achieved without an external plug-in program in the embodiment of the application, for avoiding operations such as installing a plug-in or updating a function, and improving presentation efficiency of an HTML5-protocol-based webpage. Further, since the support for the HTML5 protocol is achieved only depending on Javascript language in the embodiment of the application, the technical solutions in the application can be widely applied to various platforms supporting Javascript language, for increasing or improving webpage presentation performances of these platforms, and providing an all-platform development mode.

### Second Embodiment

In the above embodiment, the support for the HTML5-protocol-based webpage is achieved by taking Javascript language as the parsing language. In practice, the process of parsing the webpage resource by taking Javascript language as the parsing language may be implemented in many ways. Preferably, the parsing process is achieved in a way as described in the following embodiment in the application. Referring to FIG. 2, which shows a flowchart of an HTML5-protocol-based webpage presentation method according to a second embodiment of the application, the HTML5-protocol-based webpage presentation method includes steps S201 to S204 as follows.

In step S201, an HTML5-protocol-based webpage resource is acquired.

In step S202, lexical analysis is performed on the webpage resource by using Javascript language to obtain an HTML tag.

The acquired webpage resource is generally in the form of an HTML code file. To present a webpage, it needs to recognize the tag of the HTML5 from the HTML code file, so as to create the node objects of the DOM tree based on the tag. The numbers and the types of the tags supported by different HTML protocol versions are different. For example, the tags supported by the HTML5 protocol includes HTML, HEAD, STYLE, SCRIPT, LINK, BODY, DIV, IMG, A, FONT, CANVAS, BR, SVG, and webGL. To analyze to obtain the HTML tag, lexical analysis is performed on the webpage resource by using Javascript language in this embodiment. The lexical analysis may include: reading the content of the HTML code file character by character, and identifying the character subsequent to “<” as the HTML tag. For example, for a code segment “<img width=‘100’ src=‘1.gif’>”, “img” subsequent to “<” is identified as the HTML tag after the code segment is read character by character.

In step S203, a DOM object creation function is called to create the DOM object nodes according to the HTML tag.

After the HTML tag is identified, the DOM object creation function may be called to create the DOM object nodes according to the HTML tag. This process may be performed immediately after a tag is parsed, or may be performed after all HTML tags in a HTML code file are parsed. For example, in the method that the DOM object node is generated immediately after a HTML tag is parsed, the DOM object creation function, i.e., laya.document.createElement (tag name) is called according to the parsed HTML tag to generate the DOM object node corresponding to the HTML tag. And then a next tag is parsed in this step. It is to be noted, in a case that the tag has the attribute value, the DOM object set function may be called to generate the attribute of the DOM object node.

In step S204, the DOM objects are rendered and presented in a webpage.

The technical effect of the previous embodiment can also be achieved in this embodiment. Further, based on this embodiment, the technical solution in this embodiment may be modified as required to meet special requirements.

For example, in practice, to speed up the parsing, the parsing step in this embodiment may be modified as follows. Before the lexical analysis is performed on the webpage resource by using Javascript language to obtain the HTML tag, the HTML code file is compiled into the Javascript codes. After such pre-processing, no syntax analysis is needed in parsing the same code segment next time, thereby increasing the efficiency of the parsing. Still taking the above code segment as an example, assuming that the code segment “<img width=‘100’ src=‘1.gif’” appears in the code file for multiple times, this code segment is translated into the Javascript codes (pseudo-codes) as follows when the lexical analysis is performed for the first time:

function htmlCache_1(...)

{
var obj=document.createElement(“img”);
obj.set(“width”,100);
obj.set(“src”,“1.gif”);
obj.onCreated( );
}

When the code segment “<img width=‘100’ src=‘1.gif’” is parsed for a second time, the operation of parsing information such as the tag and attribute of the code segment is not needed. Instead, only htmlCache_{—}1 ( ) is needed to be called.

Further, for example, based on this embodiment, various control management operations as follows may be performed on the DOM object by using Javascript language. The tag may be added to the DOM object (e.g., [element].appendChild(element)), the tag may be deleted from the DOM object (e.g., [element].removeChild(element)), or the attribute of the node in the DOM tree may be modified (e.g., [element].setAttribute(nodeName,nodeValue)). The basic principle for achieving such management is to obtain a document (a webpage document management object), a node (a base class of the Dom object, for providing an interface to tree management and attribute operation, etc.) and an HTMLElement (for providing a basic interface to a visual element) by using Javascript language. It is to be emphasized that, as described above, conventionally, documents, nodes and HTMLElements are generally obtained by using other languages, such as C++ and JAVA, which are incompatible with the HTML5, and the problem is solved generally by using these languages. In the embodiment of the application, the implementation is performed by using Javascript language and the obtained effect is same to or even better than that in the conventional art, thereby overcoming the technical prejudice in the conventional art and obtaining a good result.

A new DOM tag may be supported by performing the above management operation. If only javascript object code for the laya.docHTML[tag namge] Element is obtained, and a designated DOM object can be generated by calling document.createElement, the div and img tag functions are obtained. Thus, according to this embodiment, new tags and function extension and updating can be obtained by the system and the developer, without updating the browser, for example

laya.doc.HTMLDivElement=function(nodeName)
{
... code
}
laya.doc.HTMLImgElement=function(nodeName)
{
... code
}

A conventional browser accesses the DOM via a javascript interface calling a local interface obtained by using C. Due to the low efficiency of calling the local interface by javascript, the advantage of the DOM of the browser can not be used in developing a large-scale online game. In this embodiment, all codes of the DOM are written in javascript, the overhead for the calling between the javascript interfaces is much less than that for the calling between the javascript and the local interface, thus the operation efficiency of the DOM is improved, and the development of a DOM coregame or large-scale project becomes possible.

### Third Embodiment

The process of parsing the page resource of the application is described in detail in the above embodiments. However, a method for rendering the generated DOM tree presentation structure, or pre-processing performed for improving the rendering and presentation efficiency before the rendering process, is not limited in the embodiment of the application, which does not affect the achieving of the object of the application. However, in practice, corresponding operations may be performed by using Javascript language in the application, for improving the individuation and efficiency in the rendering and presentation. These operations include style control, typesetting, text drawing and the like, and the procedures for performing these operations by using Javascript language are described sequentially.

As to style control, the style control is used to define the display style of the visual element of the webpage. In practice, the style control may be performed in by default (without an extra operation), or a designated style control may be performed as desired. In the style control, it needs to determine a style definition source. Generally, the style definition source includes a browser default, an external style sheet, an internal style sheet and an inline style, which are collectively referred to as the style resource. The style resource may be stored in the memory in a static manner, or may be generated temporarily as required. In this embodiment, if there is a non-default style control for at least one DOM object node in the DOM object, the style resource of the DOM tree node is compiled into the Javascript code, and the Javascript code is packaged into a function. The function will be called to perform style control on the corresponding DOM object node. The following code segment is taken as an example: tmpstyle{left:10px;top:20px;color:red}. Firstly, the style control code segment is compiled into the Javascript code:

laya.document.styleCache[“tmpstyle”]
{

this.setLeft(10);
this.setTop(20);
this.setColor(“red”);
}

Then, the Javascript code generated by compiling is packaged into a function: laya.document.styleCache[“tmpstyle”]=function( ). Thus, laya.document.styleCache[“tmpstyle”].call(this) can executed just during the style control of the rendering, without analyzing the description of {left:10px;top:20px;color:red}. As compared with the conventional style control with C++ or Java, in the style control in this embodiment the control code segment is compiled into the Javascript code segment, the user needs not to update the browser and the style sparing is speeded up.

As to typesetting, the style control is included in the webpage presentation, and the typesetting may be required based on the style control, and the typesetting operation is also triggered to modify the DOM object node, such as adding, deleting or modifying the attribute. Different from the conventional typesetting operation in C or JAVA code, in this embodiment the typesetting operation may be performed by using Javascript language as follows: collecting a changed DOM object node and a sub-node of the changed DOM object node to form a typesetting collection; calculating new attribute information of the DOM object node in the typesetting collection, where the attribute information includes wrap, position, and width; modifying the original attribute information of the DOM object node using the new attribute information; and typesetting the DOM object node based on the new attribute information.

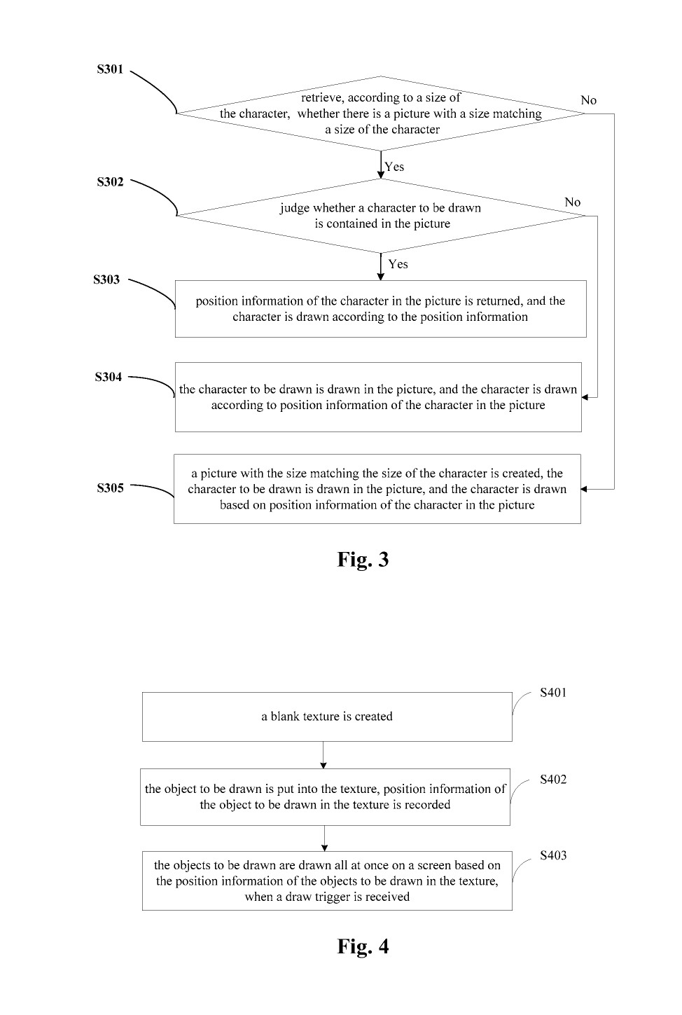

As to text drawing, when a large amount of text is to be drawn in the rendering of the page presentation, the text is conventionally drawn in a vector diagram in a low efficiency. In this embodiment, the text drawing is implemented as drawing a picture, thus improving the rending efficiency of the text drawing. Referring to FIG. 3, which shows a process for implementing the text drawing in this embodiment, the process includes steps S301 to S305 as follows.

In step S301, it is retrieved in a preset image set to determine whether there is a picture with a size matching a size of the character in the preset image set. The process proceeds to step S302 if there is the picture; or else the process proceeds to step S305.

In step S302, it is judged whether a character to be drawn is contained in the picture. If there is the character, the process proceeds to step S303; or else, proceeds to step S304.

In step S303, position information of the character in the picture is returned, and the character is drawn according to the position information. The process is ended.

In step S304, the character to be drawn is drawn in the picture, and the character is drawn according to position information of the character in the picture. The process is ended.

In step S305, a picture with the size matching the size of the character is created, the character to be drawn is drawn in the picture, and the character is drawn based on position information of the character in the picture.

As to the material combination, during the actual rending process of the page presentation, such as in the 3D or 2D on-line game circumstance, there are a large amount of characters, icons or expression animations to be drawn. Conventionally, an element is drawn each time, and the drawing on the screen totally may be beyond 200 times generally. Factors affecting the rending effects generally include graphics card drawing times and screen filling ratio, and the efficiency of the rending may be reduced significantly if the drawing times is beyond 200. To solve this problem, it is provided a material combination method, in which contents to be drawn such as characters, pictures or expression animations are combined on a blank texture that is created previously, and then are drawn all at once and submitted after filling the blank texture is finished, thereby reducing the number of the drawings of the graphics card and improving the efficiency. Referring to FIG. 4, which shows the procedure of the material combination method in this embodiment, the procedure includes steps S401 to S403 as follows.

In step S401, a blank texture is created.

The blank texture may be created by a driving layer (DirectX, OpenGL). The size of the blank texture is not limited in this embodiment, and may be determined based on the amount of the characters and icons to be drawn in practice.

In step S402, the object to be drawn is put into the texture, position information of the object to be drawn in the texture is recorded.

In this embodiment, the object to be drawn is not drawn on the screen directly. Instead, the objects to be drawn are combined in the blank texture, and the position information of each of the objects to be drawn is recorded. The object to be drawn here includes character, picture, expression animation and the like.

In step S403, the objects to be drawn are drawn all at once on a screen based on the position information of the objects to be drawn in the texture, when a draw trigger is received.

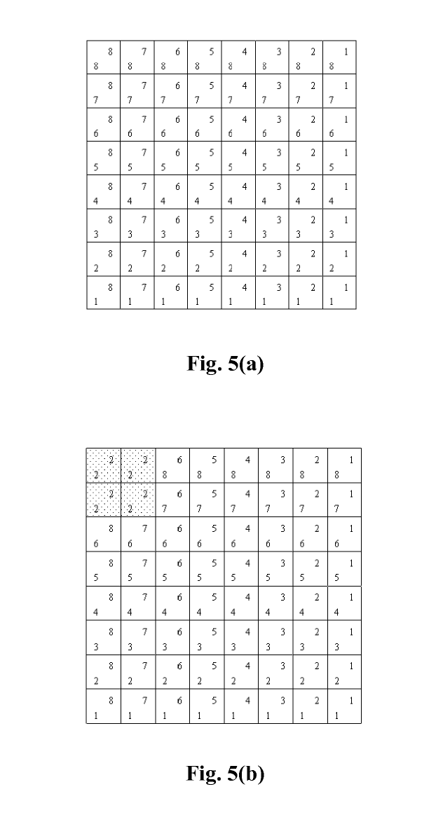

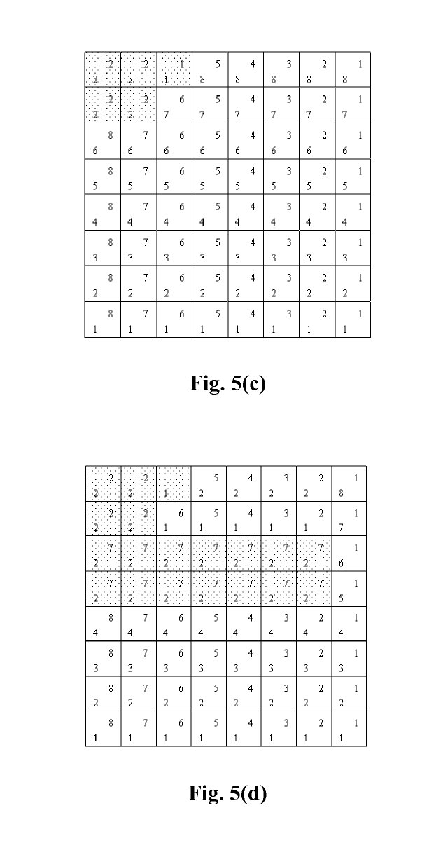

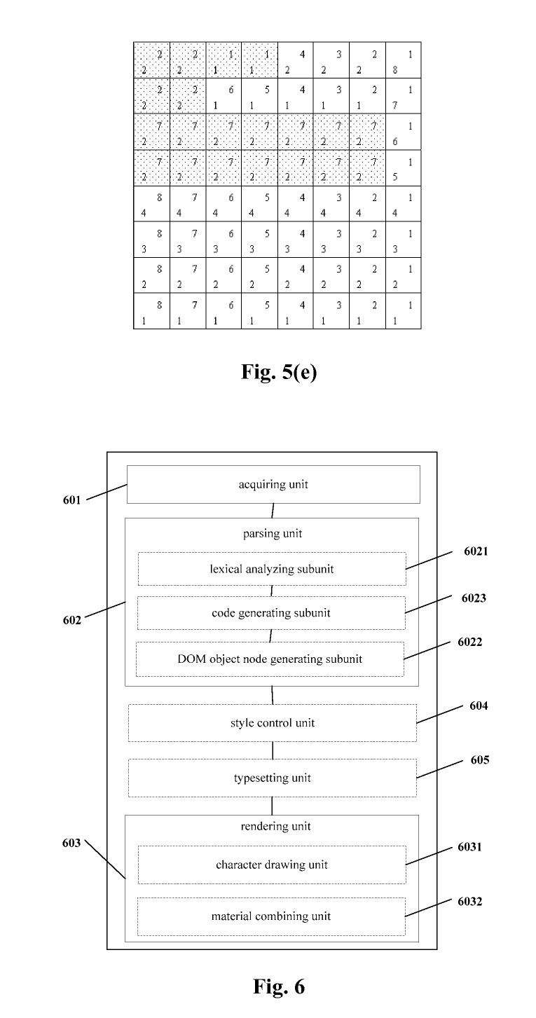

The above step S402 may be implemented in many ways. For example, a grid algorithm may be adopted, in which the blank texture is divided into multiple grids firstly (e.g., 16*16), the number of the grids to be occupied is calculated based on the information of the object to be drawn, such as the width and height, and then the grids to be occupied are traversed row by row to determine the position of the object to be drawn in the blank texture by acquiring the information of the grids. In this manner, although multiple objects to be drawn are combined in the blank texture, too many times of the repeated traverse affects the efficiency seriously. In an improved manner, each grid stores the number of continuous grids on its bottom and the number of continuous grids on its right, the states of the peripheral grids are no longer taken into consideration in each traverse, the position where the object to be drawn may be put is determined directly, then the combination operation is performed, and the information of the grid on its top or left is adjusted. Referring to FIG. 5(a) to FIG. 5(e), FIG. 5(a) shows the initial state of the blank texture, in which the blank texture is divided into 8*8 grids; FIG. 5(b) shows the texture in which an object to be drawn is filled, where the object to be drawn occupies 2*2 grids; FIG. 5(c) shows the texture in which a second object to be drawn (1*1) is filled; FIG. 5(d) shows the texture in which a third object to be drawn (7*2) is filled, in which the object to be drawn is put in the third row of the texture since it can not be put in the first row or the second row; and FIG. 5(e) shows the texture in which a fourth object to be drawn (1*1) is filled. In another improved manner, the number of the blank grids in each row is stored; and it is determined before the traverse whether the width of the object to be drawn exceeds the number of the blank grids in this row, and it turns to the next row if exceeds, and so on.

### Fourth Embodiment

The above is the description of the embodiment of the method in this application, and it is further provided an embodiment of an HTML5-protocol-based webpage presentation device. Referring to FIG. 6, which shows a structural diagram of the HTML5-protocol-based webpage presentation device, the device includes an acquiring unit 601, a parsing unit 602 and a rendering unit 603.

The acquiring unit 601 is configured to acquire an HTML5-protocol-based webpage resource.

The parsing unit 602 is configured to parse the webpage resource by using Javascript language to generate DOM object nodes.

The rendering unit 603 is configured to render the DOM objects to present a webpage.

The operation process of the device in this embodiment is as follows. Firstly, the acquiring unit 601 acquires the HTML5-protocol-based webpage resource. Then the parsing unit 602 parses the webpage resource by using Javascript language to generate DOM object nodes. Finally, the rendering unit 603 renders the DOM objects to present the webpage.

In this embodiment of the device, the HTML5-protocol-based webpage resource is acquired, then the webpage resource is parsed by using Javascript language to generate the DOM tree presentation structure, and then the DOM tree presentation structure is rendered and presented. As compared with the conventional art, Javascript language is adopted as the language for parsing the HTML5-protocol-based webpage resource in the embodiment of the device in the application. Since Javascript language is widely used in various web browsers, the support for the HTML5 protocol is achieved without an external plug-in program in the embodiment of the application, thus avoiding operations such as installing a plug-in or updating a function, and improving presentation efficiency of an HTML5-protocol-based webpage. Further, since the support for the HTML5 protocol is achieved only depending on Javascript language in the embodiment of the device in the application, the technical solutions in the application can be widely applied to various platforms supporting Javascript language, for increasing or improving webpage presentation performances of these platforms, and providing an all-platform development mode.

In the above embodiment of the device, the parsing unit may have different structures depending on different parsing manners. For example, the parsing unit 602 may include a lexical analyzing subunit 6021 and a DOM object node generating subunit 6022. The lexical analyzing subunit 6021 is configured to perform lexical analysis on the webpage resource by using Javascript language to obtain an HTML tag. The DOM object node generating subunit 6022 is configured to call a DOM object creation function to create the DOM object nodes based on the HTML tag. The parsing unit may further include a code generating subunit configured to generate Javascript code corresponding to the HTML tag, for calling the DOM object creation function to create the DOM object nodes, after the lexical analysis is performed on the webpage resource by using Javascript language to obtain the HTML tag, and the DOM object node generating subunit is configured, according to the HTML tag, to call the Javascript code corresponding the HTML tag to create the DOM object nodes.

In the above embodiment of the device, the rendering unit may include different structural units depending on how the rending operation is performed, and thus may have different internal structures. In addition, before the rendering unit, some units may be added as required, for achieving particular objects.

For example, the above device may further include a DOM object control unit configured to achieve control of the DOM object by using Javascript language, and the DOM object control unit is configured to: obtain the DOM object, a base class of the DOM object and a visual element interface by using Javascript language; add a DOM object node to and/or delete a DOM object node from the DOM object according to the HTML tag; and/or, set the attribute of the DOM object node according to the attribute of the HTML tag.

As another example, the above device may further include a style control unit 604 configured to control a style of at least one DOM object node, wherein the style control unit is configured to: compile a style resource of the DOM object node into Javascript code and package the Javascript code obtained by the compiling into a function; and call the function to perform style control on the corresponding DOM object node. If the style control process triggers the typesetting operation of the rendering, or if changes, such as addition, deletion or attribute modification, of the DOM object node takes place, the above device embodiment may further include a typesetting unit 605 configured to typeset a changed DOM object if any, wherein the change comprises addition, deletion and/or style variation of the DOM object node, and the process of typesetting a changed DOM object comprises: by using Javascript language, collecting the changed DOM object node and a sub-node of the changed DOM object node to form a typesetting collection; calculating attribute information of the DOM object node in the typesetting collection as the attribute information of the DOM object node after the change; and modifying the attribute information of the DOM object node before the change by using the attribute information of the DOM object node after the change.

As another example, if the process of rendering the DOM objects comprises drawing a character, the rendering unit 603 may include a character drawing unit 6031, and the character drawing unit 6031 includes a retrieving subunit, a judging subunit, a creating subunit, a first drawing subunit and a second drawing subunit. The retrieving subunit is configured to retrieve in a preset image set to determine whether there is a picture with the size matching the size of the character in the preset image set, trigger the judging subunit if there is a picture with the size matching the size of the character in the preset image set, or trigger the creating subunit if there is no picture with the size matching the size of the character in the preset image set. The judging subunit is configured to judge whether a character to be drawn is contained in the picture, trigger the first drawing subunit to draw the character according to position information of the character in the picture in a case that a character to be drawn is contained in the picture, or trigger the second drawing subunit to draw the character to be drawn in the picture and trigger the first drawing subunit to draw the character based on position information of the character in the picture in a case that no character to be drawn is contained in the picture. The creating subunit is configured to create a picture with the size matching the size of the character, trigger the second drawing subunit to draw the character to be drawn in the picture, and trigger the first drawing subunit to draw the character based on position information of the character in the picture.

As another example, if the process of rendering the DOM objects includes combining materials, the rendering unit 603 includes a material combining unit 6032, and the material combining unit 6032 includes a texture creating subunit, a position information recording subunit and a third drawing subunit. The texture creating subunit is configured to create a blank texture. The position information recording subunit is configured to put the object to be drawn into the texture and record position information of the objects to be drawn in the texture. The third drawing subunit is configured to draw the objects to be drawn all at once on a screen according to the position information of the objects to be drawn in the texture upon reception of a draw trigger.

For convenience of description, the above device is described in various units corresponding to functions. In practice, the functions of the various units may be implemented in one or more software and/or hardware. For example, the above device for achieving the webpage presentation may be combined with other functions of a browser to form one browser which is able to support the HTML5.

As is known clearly by those skilled in the art from the above description of the embodiments, this application may be implemented by means of software in conjunction with necessary general hardware platform. Based on the understanding, the technical solution of the application or the part contributing to the conventional art may be embodied in a software product. The computer software product may be stored in a storage medium such as a ROM/RM, a magnetic disk, or an optical disk. The computer software product includes instructions to cause a computer device (which may be a personal computer, a server, a network device or the like) to implement the method in the embodiments or some parts of the embodiments in the application.

In the present specification, the embodiments are described in progression, each embodiment emphasizes the difference aspect from other embodiments, and reference can be made to these similar parts among the embodiments. Since the embodiment of the system is similar to that of the method, and is described briefly, and reference may be made to the description of the method for related points. The embodiments of the system described above are merely illustrative. The units described as separated components may be or may be not separated physically. The component as a unit may be or may be not a physical unit, i.e., may be located in one position, or may be distributed on multiple network units. Some or all of the modules may be selected as required to achieve the object of the solution of the embodiment, which can be understood and implemented by those skilled in the art without creative labor.

This application may be applicable to various general or dedicated computing system circumstances or configurations, such as a personal computer, a server computer, a handheld device or portable device, a tablet device, a multi-processor system, a microprocessor-based system, a top box, a programmable consumer electronic device, a network PC, a mini computer, a mainframe computer, or a distributed computing circumstance including any of the above systems or devices.

This application may be described in the general context of computer executable instructions executed by the computer, such as a program module. Generally, the program module includes a routine, a program, an object, an assembly, a data structure and the like for performing a particular task or achieving a particular abstract data type. This application may also be implemented in the distributed computing circumstance. In these distributed computing circumstances, the tasks are executed by remote processing devices connected via a communication network. In the distributed computing circumstance, the program module may be located in the local or remote computer storage medium including the storage device.

The above are merely embodiments of the application. It is to be noted, modifications and variations may be made by those skilled in the art without deviating from the principle of the application, and the modifications and variations should also be deemed as falling within the scope of protection of the application.

What is claimed is:

1. An HTML5-protocol-based webpage presentation method, comprising:
acquiring an HTML5-protocol-based webpage resource;
parsing the webpage resource by using Javascript language to generate (document object model) DOM object nodes; and
rendering the DOM objects and performing webpage presentation.

2. The method according to claim 1, wherein the parsing the webpage resource by using Javascript language to generate DOM object nodes comprises:
performing lexical analysis on the webpage resource by using Javascript language to obtain an HTML tag; and
calling a DOM object creation function to create the DOM object nodes according to the HTML tag.

3. The method according to claim 2, wherein, after the performing lexical analysis on the webpage resource by using Javascript language to obtain an HTML tag, Javascript code corresponding to the HTML tag and for calling the DOM object creation function to create the DOM object nodes is generated, and the calling a DOM object creation function to create the DOM object nodes according to the HTML tag comprises:
according to the HTML tag, calling the Javascript code corresponding to the HTML tag to create the DOM object nodes.

4. The method according to claim 1, further comprising achieving control of a DOM object by using Javascript language, wherein the achieving control of the DOM object by using Javascript language comprises:
obtaining the DOM object, a base class of the DOM object and a visual element interface by using Javascript language;
adding a DOM object node to and/or deleting a DOM object node from the DOM object according to the HTML tag; and/or
setting an attribute of the DOM object node according to an attribute of the HTML tag.

5. The method according to claim 1, further comprising controlling style of at least one DOM object node, wherein the controlling style of at least one DOM object node comprises:
compiling a style resource of the DOM object node into Javascript code and packaging the Javascript code obtained by the compiling into a function; and
calling the function to perform style control on the corresponding DOM object node.

6. The method according to claim 5, further comprising typesetting a changed DOM object if any, wherein a change comprises addition, deletion and/or style variation of the DOM object node, and the typesetting a changed DOM object comprises: by using Javascript language,
collecting the changed DOM object node and a sub-node of the changed DOM object node to form a typesetting collection;
calculating attribute information of the DOM object node in the typesetting collection; and
modifying the attribute information of the DOM object node before the change by using the attribute information of the DOM object node after the change.

7. The method according to claim 1, wherein the rendering the DOM object comprises drawing a character, and the drawing a character comprises:
retrieving in a preset image set to determine whether there is a picture with a size matching a size of the character in the preset image set; and
in a case that there is a picture with the size matching the size of the character in the preset image set, judging whether a character to be drawn is contained in the picture, drawing the character based on position information of the character in the picture in a case that a character to be drawn is contained in the picture, or drawing the character to be drawn in the picture and drawing the character according to position information of the character in the picture in a case that no character to be drawn is contained in the picture; or
in a case that there is no picture with the size matching the size of the character in the preset image set, creating a picture with the size matching the size of the character, drawing the character to be drawn into the picture, and drawing the character according to position information of the character in the picture.

8. The method according to claim 1, wherein the rendering the DOM objects comprises combining materials, and the combining materials comprises:
creating a blank texture;
putting an object to be drawn into the texture, and recording position information of the object to be drawn in the texture; and
drawing objects to be drawn onto a screen all at once according to the position information of each of the objects to be drawn in the texture, when receiving a draw trigger.

9. An HTML5-protocol-based webpage presentation device, comprising an acquiring unit, a parsing unit and a rendering unit, wherein
the acquiring unit is configured to acquire an HTML5-protocol-based webpage resource;
the parsing unit is configured to parse the webpage resource by using Javascript language to generate (document object model) DOM object nodes; and
the rendering unit is configured to render the DOM objects and perform webpage presentation.

10. The device according to claim 9, wherein the parsing unit comprises a lexical analyzing subunit and a DOM object node generating subunit, wherein
the lexical analyzing subunit is configured to perform lexical analysis on the webpage resource by using Javascript language to obtain an HTML tag; and
the DOM object node generating subunit is configured to call a DOM object creation function to create the DOM object nodes according to the HTML tag.

11. The device according to claim 10, wherein the parsing unit further comprises a code generating subunit configured, after the lexical analysis is performed on the webpage resource by using Javascript language to obtain the HTML tag, to generate Javascript code corresponding to the HTML tag and for calling the DOM object creation function to create the DOM object nodes, and the DOM object node generating subunit is configured to call the Javascript codes corresponding to the HTML tag to create DOM object nodes.

12. The device according to claim 9, further comprising a DOM object control unit configured to achieve control of a DOM object by using Javascript language, and the DOM object control unit is configured to:
obtain the DOM object, a base class of the DOM object and a visual element interface by using Javascript language;
add a DOM object node to and/or delete a DOM object node from the DOM object according to the HTML tag; and/or
set an attribute of the DOM object node according to an attribute of the HTML tag.

13. The device according to claim 9, further comprising a style control unit configured to control a style of at least one DOM object node, wherein the style control unit is configured to:
compile a style resource of the DOM object node into Javascript code and package the Javascript code obtained by the compiling into a function; and
call the function to perform style control on the corresponding DOM object node.

14. The device according to claim 13, further comprising a typesetting unit configured to typeset a changed DOM object if any, wherein the a change comprises addition, deletion and/or style variation of the DOM object node, and a process of typesetting a changed DOM object comprises: by using Javascript language,
collecting the changed DOM object node and a sub-node of the changed DOM object node to form a typesetting collection;
calculating attribute information of the DOM object node in the typesetting collection; and
modifying the attribute information of the DOM object node before the change by using the attribute information of the DOM object node after the change.

15. The device according to claim 9, wherein a process of rendering the DOM objects comprises drawing a character, the rendering unit comprises a character drawing unit, and the character drawing unit comprises a retrieving subunit, a judging subunit, a creating subunit, a first drawing subunit and a second drawing subunit, wherein
the retrieving subunit is configured to retrieve in a preset image set to determine whether there is a picture with a size matching a size of the character in the preset image set, trigger the judging subunit if there is a picture with the size matching the size of the character in the preset image set, or trigger the creating subunit if there is no picture with the size matching the size of the character in the preset image set;
the judging subunit is configured to judge whether a character to be drawn is contained in the picture, trigger the first drawing subunit to draw the character according to position information of the character in the picture in a case that the character to be drawn is contained in the picture, or trigger the second drawing subunit to draw the character to be drawn in the picture and trigger the first drawing subunit to draw the character according to position information of the character in the picture in a case that no character to be drawn is contained in the picture; and
the creating subunit is configured to create a picture with the size matching the size of the character, trigger the second drawing subunit to draw the character to be drawn in the picture, and trigger the first drawing subunit to draw the character according to position information of the character in the picture.

16. The device according to claim 9, wherein a process of rendering the DOM objects comprises combining materials, the rendering unit comprises a material combining unit, and the material combining unit comprises a texture creating subunit, a position information recording subunit and a third drawing subunit, wherein
the texture creating subunit is configured to create a blank texture;
the position information recording subunit is configured to put an object to be drawn into the texture and record position information of the object to be drawn in the texture; and
the third drawing subunit is configured to draw all objects to be drawn onto a screen all at once according to the position information of each of the objects to be drawn in the texture when receiving a draw trigger.

17. The method according to claim 2, further comprising achieving control of a DOM object by using Javascript language, wherein the achieving control of the DOM object by using Javascript language comprises:
obtaining the DOM object, a base class of the DOM object and a visual element interface by using Javascript language;
adding a DOM object node to and/or deleting a DOM object node from the DOM object according to the HTML tag; and/or
setting an attribute of the DOM object node according to an attribute of the HTML tag.

18. The method according to claim 3, further comprising achieving control of a DOM object by using Javascript language, wherein the achieving control of the DOM object by using Javascript language comprises:
obtaining the DOM object, a base class of the DOM object and a visual element interface by using Javascript language;
adding a DOM object node to and/or deleting a DOM object node from the DOM object according to the HTML tag; and/or
setting an attribute of the DOM object node according to an attribute of the HTML tag.

19. The device according to claim 10, further comprising a DOM object control unit configured to achieve control of a DOM object by using Javascript language, and the DOM object control unit is configured to:
obtain the DOM object, a base class of the DOM object and a visual element interface by using Javascript language;
add a DOM object node to and/or delete a DOM object node from the DOM object according to the HTML tag; and/or
set an attribute of the DOM object node according to an attribute of the HTML tag.

20. The device according to claim 11, further comprising a DOM object control unit configured to achieve control of a DOM object by using Javascript language, and the DOM object control unit is configured to:
obtain the DOM object, a base class of the DOM object and a visual element interface by using Javascript language;
add a DOM object node to and/or delete a DOM object node from the DOM object according to the HTML tag; and/or
set an attribute of the DOM object node according to an attribute of the HTML tag.
